(19) United States
(12) Patent Application Publication
(10) Pub. No.: US 2012/0223231 A1
(43) Pub. Date: Sep. 6, 2012

(54) PROXIMITY SENSOR HAVING ELECTRO-LESS PLATED SHIELDING STRUCTURE

(75) Inventor: Suresh Basoor NIJAGUNA, Regent Heights (SG)

(73) Assignee: LITE-ON SINGAPORE PTE. LTD., Northtec (SG)

(21) Appl. No.: 13/037,565

(22) Filed: Mar. 1, 2011

(51) Int. Cl. G01J 5/10; G01J 1/42

(52) U.S. Cl. 250/338.1; 250/216

(57) ABSTRACT

The instant disclosure relates to a proximity sensor having an electro-less plated optical shielding structure. The sensor includes a substrate panel having an emitter region and a receiver region; an emitter unit disposed on the emitter region and configured to emit electromagnetic signals at a particular wavelength; a receiver unit disposed on the receiver region and configured to respond to electromagnetic signals emitted by the emitter unit; a transparent molding unit disposed on the emitter region and the receiver region of the substrate panel; and an optical shielding layer selectively disposed on the external surfaces of the substrate panel and the transparent molding unit. The shielding layer has corresponding sensor ports for the emitter and the receiver units arranged toward a designated detection region. The electro-less plated optical shielding layer is highly configurable through proper masking and small in thickness, enabling further miniaturization of the sensor unit.

### FIELD OF THE INVENTION

The instant disclosure relates to a shielding structure for a photoelectric proximity sensor, and more particularly, to an electro-less plated shielding structure for a photoelectric sensor capable of effectively preventing optical cross-talk.

### BACKGROUND

Proximity sensors (PS), also known as proximity switches, are sensors designed to detect the presence of nearby objects without physical contact. Typical applications of the proximity sensors include the control, detection, position, inspection and automation of machine tools and manufacturing systems. They are also applicable in the packaging, production, printing, plastic molding, metal working, food processing machinery, etc. Moreover, with the advancement in miniaturized personal electronics, the physical dimensions of modern proximity sensors have been reduced to enable their application in numerous miniature electronic devices. One exemplary application of proximity sensor in modern miniature personal electronics is touch-panel mobile phone. Particularly, large-area touch-panels on modern mobile phones provide convenient and intuitive operation interface for a user. However, during certain operations, such as when the user brings the mobile phone close to his/her face during conversations, the touch-panel of the phone will inevitably contact the user's body parts and thus be operated unintentionally. With increasing adaptation of touch panel on mobile phones, there is an increasing need for optical proximity sensor to be used in mobile phones to detect a user's face and deactivate touch pads during mobile communications.

There are various types of proximity sensors. Popular types of proximity sensor include the inductive sensors, capacitive sensors, magnetic sensors, and photoelectric sensors. While the technical implementation behind each type of proximity sensor may be different, the design concept often revolves around similar operating principles. A proximity sensor generally includes an emitter and a receiver. The emitters of the proximity sensors are designed to emit an electromagnetic/electrostatic field or a beam of electromagnetic radiation, while the receivers are designed to detect the changes in the emitted field or the difference in the return signal, thus providing the basis for determining the presence of objects/targets in particular vicinity without physical contact. Proximity sensors often have higher reliability and longer functional life thanks to the absence of mechanical parts and the lack of physical contact with the target objects (called the actuators). Moreover, different types of proximity sensors are often suitable for detecting targets objects of different natures.

Inductive proximity sensors are most suitable for non-contact detection of metallic objects. Their operating principle is based on a coil and oscillator that creates an electromagnetic field in the close surroundings of the sensing surface. The presence of a metallic actuator in the operating area would cause a dampening of the oscillation amplitude. The rise or fall of such oscillation is then identified by a threshold circuit that changes the output of the sensor. The operating distance (called the nominal range) of the sensor often depends on the actuator's shape and size and is strictly linked to the nature of the composition material thereof.

Capacitive proximity sensors are adaptable for sensing metallic objects & nonmetallic objects alike (liquid, plastic, wooden materials and so on). Capacitive proximity sensors use the variation of capacitance between the sensor and the object being detected. When the object is at a preset distance from the sensitive side of the sensor, an electronic circuit inside the sensor begins to oscillate. The rise or the fall of such oscillation is identified by a threshold circuit that drives an amplifier for the operation of an external load. A screw placed on the backside of the sensor allows the adjustment of the sensitivity and nominal range of the unit. The sensitivity regulation is useful in applications such as detection of full containers and non-detection of empty containers. The nominal range of the sensor also depends on the actuator shape and size and is strictly linked to the nature of the material thereof.

Magnetic proximity sensors are actuated by the presence of permanent magnets. Their operating principle is based on the use of reed contacts having thin plates hermetically sealed in a glass bulb with inert gas. The presences of a magnetic field makes the thin plates flex and touch each other, thus establishing an electrical contact. The plate surface of the reed contact has been treated with a special material particularly suitable for low current or high inductive circuits. Magnetic sensors possess many advantageous characteristics comparing to traditional mechanical switches, including: (1) the contacts of the switch are well protected against dust, oxidization and corrosion due to the hermetic glass bulb and inert gas filling; (2) the contacts are activated by means of a magnetic field rather than mechanical parts; (3) special surface treatment of contacts assures long contact life; (4) maintenance free; (5) easy operation; and (6) reduced size.

Photoelectric proximity sensors utilize light sensitive elements to detect objects and are often made up of an emitter (light source) and a receiver. Basing on the operational arrangements, photoelectric sensors can be roughly categorized into the following four types: (1) direct-refection type, (2) reflection with reflector type, (3) polarized reflection with reflector, and (4) through-beam type.

Direct-reflection sensors have their emitter and receiver placed in the same housing unit and use the light reflected directly off the object for detection. It is worth mentioning that for photo-detectors of this type, the nominal range and accuracy would be affected by the color and the surface characteristics of the target object. For targets having opaque surfaces, the sensing distance of the unit is affected by the color of the object. Lighter colors would correspond to the longer sensing distances due to their better light-reflecting nature and vice versa. For actuators having shiny surfaces, the reflective effect of the surface becomes more important than the color.

Reflectors type photoelectric sensors require separate reflectors in conjunction with an integrated emitter/receiver unit. The emitter unit of the sensor emits a beam of electromagnetic wave toward the reflector, which is arranged to reflect the incoming beam back to the sensor's receiver unit. An object is detected when it interrupts the light beam between the sensor and reflector. This type of sensor allows longer sensing distances, as the emitter's output signals are almost totally reflected towards the receiver.

The polarized-reflector type photoelectric sensor shares much similarity with the reflector-type sensor but further include an anti-reflex device. The anti-reflex device bases its functioning on a polarized band of light and offers considerable more secure readings even when the object to be sensed has a very shiny surface. Detectors of this type tend to be less affected by random reflections.

Through Beam type photoelectric sensors have their emitter and receiver units housed separately. The detection of an actuator occurs when the target interrupts the light beam between the emitter and receiver. This type of sensors allow for the longest nominal range.

Like many other sensor devices, cross-talk is one of the major factors that compromise the accuracy of a photoelectric sensor. In electronics, crosstalk (XT) is any phenomenon by which a signal transmitted on one circuit or channel of a transmission system creates an undesired effect in another (usually adjacent) circuit or channel. A telecommunication signal that disrupts a signal in an adjacent circuit may cause the signals to become confused and cross over each other. For photoelectric sensors, and particularly for direct-reflection type, optical crosstalk refers to the interference of the optical sensor at the receiver end by optical signals not properly reflected from an intended detection zone. The interfering signals may be from an external source. However, for a direct-reflection type photoelectric sensor, the crosstalk signals are often originated from the emitter unit of the sensor itself. For a reflection-type proximity sensor whose operating principle relies on the detection of rebounding signals from a target object, if the structure of the sensor is not carefully designed to provide effective optical shielding between the emitter unit and the receiver unit, part of the optical signal generated by the sensor's emitter may diffuse toward the sensor's receiver. In some extreme cases, optic signals from the emitter unit may propagate through the internal structure of the sensor device, such as the gap between the housing walls or through the printed circuit board (PCB), and reach the receiver unit. The reception of these bypassing signals at the receiver unit violates the operating principle of the photoelectric sensors and may greatly compromise the accuracy and sensitivity thereof.

Various optical shielding structures are developed to address the optical crosstalk issue of photoelectric sensors. Conventional measures against optical crosstalk often involve the provision of a metal shielding case having an emitting and a receiving opening correspondingly disposed toward a designated detection region. One of a more sophisticated example of such metal shielding structure for preventing crosstalk between a transmitter and a receiver of a photoelectric sensing device is illustrated in FIG. 1a. Specifically, the structure of the optical shielding device 100a has two separate and isolated compartments 101a and 102a for hosting an emitter unit and a receiving unit respectively. The external structure of each compartment has an aperture 103a/104a correspondingly arranged toward an intended detection zone. Moreover, the shielding device 100a may be constructed simply by folding a single-piece stainless steel foil of a particular shape, as shown in FIG. 1b. The one-piece construction of the optical shield reduces the number of required parts and thus the manufacturing cost. However, the physical dimension of a separately constructed shielding structure may be too big and heavy for today's miniature electronic devices.

To reduce the physical dimension of the shielding unit, one conventional technique is to provide an optical shield insertion unit directly over the receiver unit on the sensor's PCB, as shown in FIG. 2. Specifically, the conventional photoelectric sensor device includes an emitter unit 20a and a receiver unit 30a disposed on an emitter region and a receiver region of a substrate unit 10a (such as a PCB). The emitter unit 20a and the receiver unit 30a are respectively covered and protected by a transparent shielding layer 40a. A separate add-on metal shield insertion 50a is installed over the receiver region of the transparent molding unit 40a on the substrate unit 10a to provide blockage of undesired optical inputs from directions other than the intended detection region.

These sub-PCB-level shield insertions 50a may technically be manufactured in sizes compact enough to meet the miniaturization requirements. The small shield insertions are then disposed onto the sensor's PCB by glue or other coupling means. However, in practice, these miniature metal shield insertions require specialized shield attaching machines for mass production, and often fall off from the designated attaching surfaces during or after the manufacturing process due to difficulties in precision glue dispensing. In addition, the optical shield insertions 50a, which are often made of metallic materials such as metal foils, still possess noticeable thickness and require significant amount of space of accommodation.

### SUMMARY

In view of the draw-backs of the conventional approaches for the aforementioned problems, one object of the instant disclosure is to provide an optical-shield of neglectable thinness at micrometer scale for a photoelectric proximity sensor to provide effective optical shielding from both external and internal interfering sources.

Another object is to provide an optical shielding structure preferably comprising an electro-less-plated metallic layer that is securely disposed on the photoelectric sensor and selectively covers the desired surface area thereof.

Yet another object is to provide an optical shield of small thickness that has high adaptability and conformability to the structural surface on which it is disposed.

Still another object is to provide a crosstalk preventing layer that has high application flexibility and can be easily configured to suit photoelectric detectors of different shielding arrangements.

Yet still another object is to provide a metallic optical shielding layer having high coverage-selectivity on the surface of a photoelectric sensor to further enhance the anti-electrostatic-discharge (anti-ESD) performance thereof and/or to establish compact electrical contacts thereon.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the instant disclosure. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be explicitly noted, however, that each of the figures is provided for the purpose of illustration and description only and is not intended as a definition of the limits of the instant disclosure.

### BRIEF DESCRIPTION OF THE DRAWINGS

FIG. 1a illustrates a perspective structure of a first conventional optical shield for a photoelectric proximity sensor (prior art).

FIG. 1b illustrates an unfolded structural layout of the conventional optical shield of FIG. 1a (prior art).

FIG. 2 illustrates a perspective layout of a second conventional optical shield for a photoelectric proximity sensor (prior art).

FIG. 3 illustrates a prospective view of a proximity sensor having an optical shielding layer according to the instant disclosure.

FIG. 4 illustrates a partition groove structure for a proximity sensor according to the instant disclosure.

FIG. 5 illustrates a first preparation step for a proximity sensor in accordance with the instant disclosure.

FIG. 6 illustrates a second preparation step for a proximity sensor in accordance with the instant disclosure.

FIG. 7 illustrates a third preparation step for a proximity sensor in accordance with the instant disclosure

FIG. 8 illustrates an optical shielding layer in accordance with the instant disclosure arranged to serve as an anti-ESD (electrostatic discharge) device.

FIG. 9 illustrates a plurality of electrical contacts created through an electro-less plating process according to the instant disclosure.

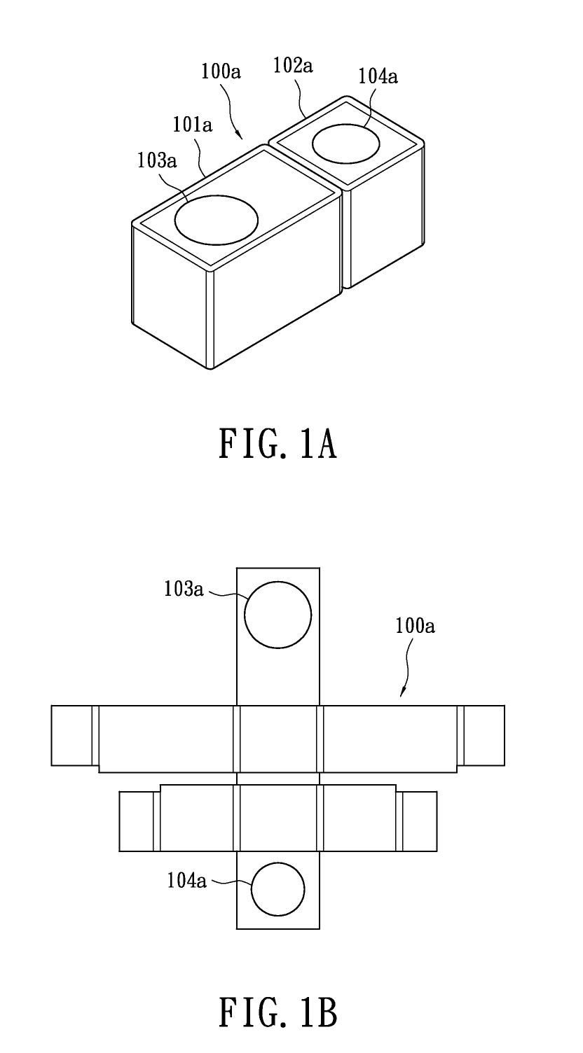

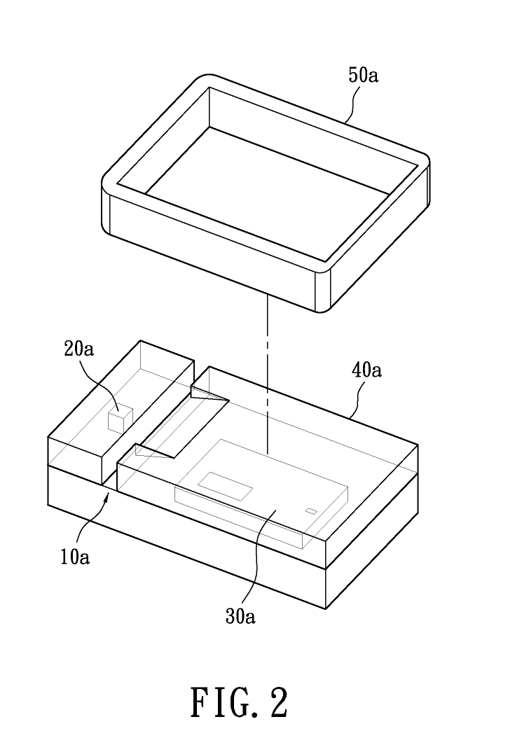

### DETAILED DESCRIPTION

The instant disclosure will be described more specifically with reference to the following embodiments. It is to be noted that the following descriptions of preferred embodiments are provided herein for purpose of illustration and description. It is not intended to be exhaustive or limiting to the precise form disclosed.

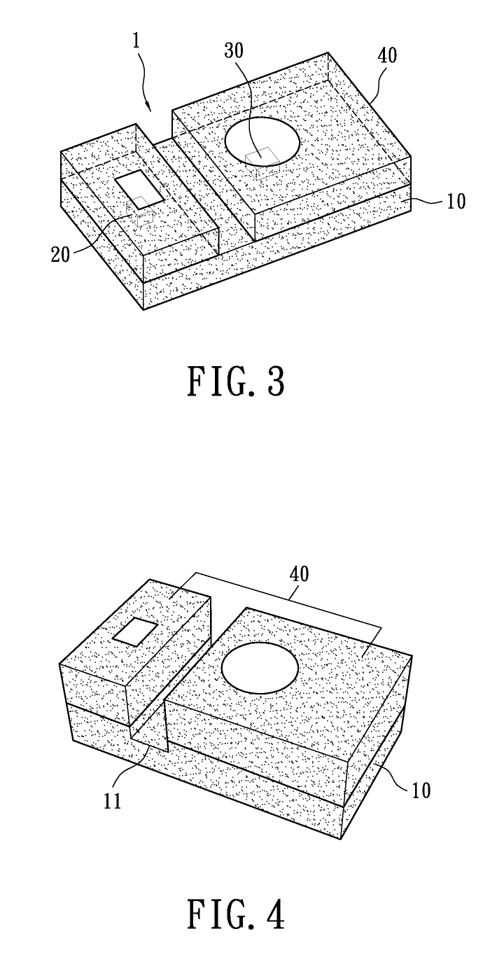

FIGS. 3 illustrate a preferred embodiment of a photoelectric proximity sensor in accordance with the instant disclosure. The photoelectric sensor 1 comprises an emitter unit 20 and a receiver unit 30 disposed in an emitter region and a receiver region of a substrate unit 10, respectively; the emitter unit 20 and the receiver unit 30 are respectively covered and protected by a transparent molding unit 40; furthermore, a optic shielding layer (the area shaded in gray color) is selectively disposed on the surface of the proximity sensor over the emitter and the receiver regions.

The substrate panel 10 provides the structural foundation for the proximity sensor unit. The substrate panel may comprise at least one PCB made of BT-epoxy, cyanate ester, Flame Resistant 2 (FR-2), Flame Resistant 4 (FR-4), ceramic substrates, or other non-metallic materials. The emitter unit 20, which can be a light-emitting-diode (LED) or any light wave generating device, is disposed in an emitter region that is preferably defined on the surface of the substrate panel 10. The emitter unit 20 may be die-attached to the surface of the substrate panel 10 through techniques such as flip-chip or wire bonding. The emitter unit 20 is configured to emit electromagnetic signals at a particular wavelength preferably in the infrared spectrum. However, the emitter unit may be configured to emit electromagnetic signals in a wide spectrum of wavelengths, depending on specific application of the sensor device. For example, the emitter may be configured to output electromagnetic signals in the range of visible light for low cost applications; or it may be designed to emit high energy X-ray beams for use in sophisticated X-ray scanning devices. Similarly, the receiver unit 30, such as a detector IC, is disposed in a receiver region that is preferably defined on the surface of the substrate panel 10. The receiver unit 30 is configured to be responsive to the electromagnetic signals emitted by the emitter unit 20. Of course, the emitter unit 20 and the receiver unit 30 do not need to be physically mounted on the surface of the substrate panel 10. They may be mounted in elevation or in declination with respect to the surface of the substrate panel 10 to accommodate heat-exchange devices for improving heat-dissipating characteristics or for other purposes. Nevertheless, the instant disclosure employs direct placement of the emitter/receiver units on the substrate panel for structural simplicity and manufacturing cost-effectiveness.

The transparent molding unit 40 is disposed over the emitter unit 20 and the receiver unit 30 to provide physical protection and/or structural support. The molding unit 40 may be a layer of clear mold compound that is optically transparent (or translucent) to the specific wavelength emitted by the emitter unit 20. Exemplary material for the transparent molding unit 40 includes transparent epoxy, resin, and other suitable transparent molding materials. Moreover, it is preferable to form a structural separation in the transparent molding unit 40 between the emitter region and the receiver region to achieve better optical isolation there-between.

An optical shielding layer is selectively disposed on the external surfaces of the substrate panel 10 and the transparent molding unit 40 to provide optical shielding. As illustrated by the area shaded in gray color in FIG. 3, the optical shielding layer is a thin metallic layer of micrometer scale, preferably under 50 um. Specifically, the instant embodiment employs a thin shielding layer made by an electro-less plating process.

Electro-less plating technique is known for its ability to produce uniform and durable coating layers of great thinness. Specifically, electro-less plating process is an autocatalytic chemical reduction process upon initiation. The process is similar to electroplating except that no outside current is needed. The metal ions are reduced by chemical agents in the plating solutions and deposited on the surface of a substrate. One major advantage of electro-less plating technique is that it can be used for coating non-metallic parts, such as the electrically insolating materials of PCBs. For decorative purposes, electro-less plating layers are usually further coated with electrodeposited nickel and chromium. There are also applications for electro-less deposits on metallic substrates, especially on irregularly shaped objects that require uniform coatings, to avoid the formation of nodular deposits. Nodular deposit is a deposit commonly obtained through electroplating characterized by its irregular thickness due to un-uniform density of driving currents. Thus, the elimination of external driving current in the plating process effectively solves the problem of non-uniform current distribution through the coated object, thereby eliminating the formation of nodular deposits. Electro-less copper is used extensively in the manufacture of printed circuits, which are produced either by coating non-metallic substrates with a very thin layer of copper through electro-less plating technique and then performing electroplating on the copper layer to form metallic layers of desired thickness, or by using the electro-less process solely. Electro-less gold plating technique is used for microcircuits and connections to solid-state (non-metal) components, where deeply recessed areas that are difficult to plate can be uniformly coated through the electro-less plating process.

The Electro-less plating is done only on those surfaces that require optical shielding. The rest of the surface areas on the photoelectric sensor unit are masked to prevent plating on the functional portions of the module, such as the optical ports of the sensor unit. Particularly, the surface of the transparent molding unit 40 and the substrate panel 10 will be selectively masked before the electro-less plating process takes place to create an emitter window that corresponds to the emitter unit and a receiver window that corresponds to the receiver unit. Proper surface treatment during this step on the desired coating area may ensure the production of more durable coating layers. The emitter window and the receiver window are correspondingly arranged toward a designated detection region. Also, the bottom of the substrate panel 10 may be masked to avoid the deposit of electrical contacts between the pin-outs or the mating surfaces of the sensor unit, thus preventing shorting or other problems.

A partition groove 11 may be formed on the surface of the substrate panel 10 to separate the emitter region from the receiver region for providing better optical isolation. As shown in FIG. 4, one embodiment in accordance with the instant disclosure has a partition groove 11 formed on the top surface of the substrate panel 10. The partition groove 11 on the substrate panel 10 may be formed by molding the substrate in advance or by cutting/sawing the substrate afterwards. Preferably, the partition groove 11 of the substrate panel 10 is arranged in alignment with the separating structure formed in the transparent molding unit 40. The surfaces of the combined partition groove, which effectively separates the emitter unit 20 from the receiver unit 30, may then be coated by a metal layer (illustrated by the area shaded in gray color) through coating methods such as electro-less plating to form the crosstalk preventing shielding layer.

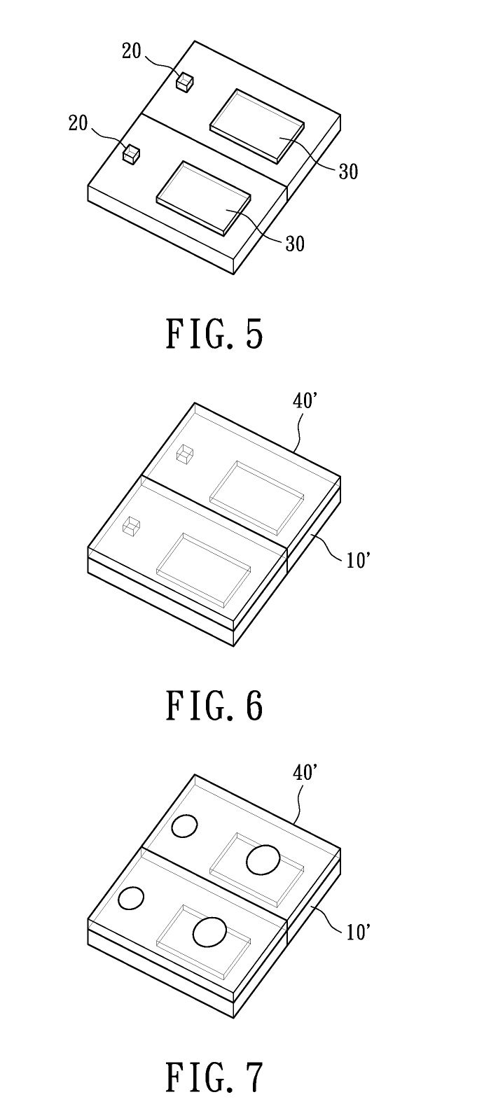

Please refer to FIGS. 5, 6, and 7, which illustrate the preparation steps for proximity sensor units in accordance with the instant disclosure. First referring to FIG. 5. A plurality of proximity sensor units is prepared on a base substrate panel 10′. For illustration simplicity, the present embodiment (as illustrated in FIG. 5) only shows two of such units. During this step, the emitter units (which can be IR emitting LEDs or other forms of emitters) and the receiver units (for example, the detector ICs) are die-attached and wire bonded onto the base panel. While the instant embodiment employs wire bonding technique as the choice of die-attachment, it should be noted that the bonding technique applicable for the preparation of the detector units should not be limited by the exemplary illustration.

Referring to FIG. 6, which shows the deposition of the transparent molding unit 40′ over the emitter unit 20 and the receiver unit 30. As previously discussed, the transparent molding unit 40′ is optically transparent (or translucent) to the specific wavelength emitted by the emitter unit 20. The molding unit 40′ may be a layer of clear mold compound if the emitter unit 20 is an integrated ambient and proximity sensor IC, or it may be made of IR-passing compound if the emitter 20 is only a proximity detector IC. Exemplary material for the transparent molding unit 40′ includes transparent epoxy, resin, and other suitable transparent molding materials.

FIG. 7 illustrates the masking step for the proximity sensor unit prior to the electro-less plating process. As previously discussed, the masking layers are selectively placed on those surfaces that do not need optical shielding, such as the optical ports for the emitter 20 and the receiver 30. The masking of the optical ports is carried out on the transparent molding unit 40′ in correspondence with the emitter unit 20 and the receiver unit 30 toward a designated detection region. Also, the bottom surface of the substrate is preferably masked to avoid deposition of metallic layers between the pin-outs or the mating surfaces of the sensor unit, as conducting materials on these locations may potentially cause shorting or other problems.

A singulation step will take place to separate individual sensor units from the base substrate 10′. During this procedure, the clear molded substrate will be sawn around its peripheral and between the emitter region and the receiver region to form surfaces for metal plating by electro-less plating. Sawing devices having thickness of 0.5 mm or less is preferred for the sawing operation. Moreover, the disposition of the partition groove 11 between the emitter region and the receiver region of the individual proximity sensor unit may be performed during the cutting procedure, thereby partitioning the substrate panel into two separated detector regions. It is to be noted that the sawing/singulation step and the masking step may be carried out in interchangeable order depending on specific manufacturing or operational requirements. Nevertheless, for manufacturing efficiency, the instant embodiment utilizes a centralized masking process on the plurality of sensor units on the base substrate before carrying out the sawing process (as illustrated in FIG. 7).

The deposition of the optical shielding layer, preferably through the electro-less plating technique, is carried out following the selective masking of the proximity sensor unit. It is to be noted that the thin metallic shielding layer created through the electro-less plating process is not only durable and uniform in thickness; it also possesses high adaptability and conformability to the structural surface on which it is disposed. Furthermore, the crosstalk preventing layer created by electro-less plating technique can be highly configurable through sophisticated masking arrangement to suit photoelectric detectors of different shielding arrangements.

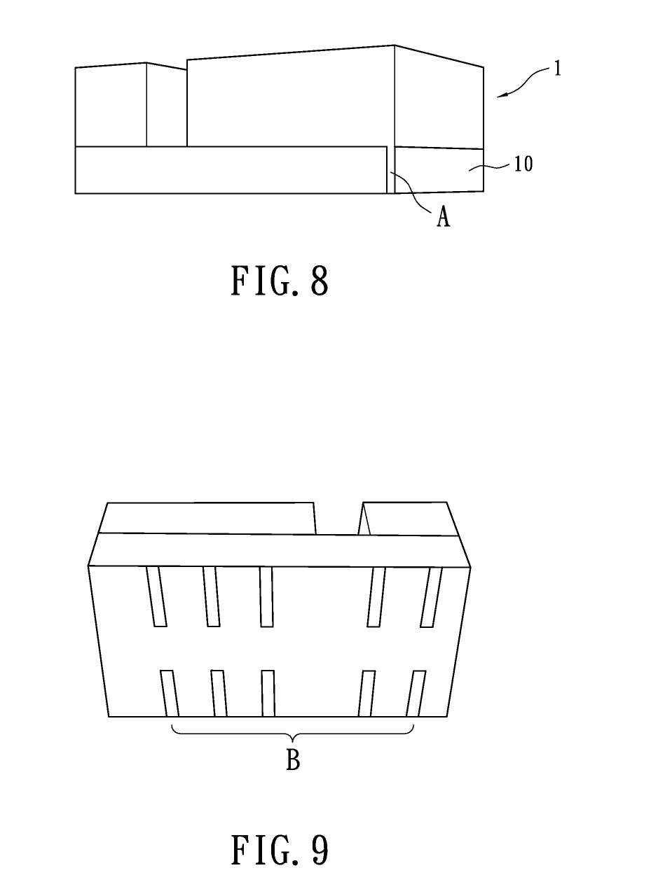

Sophisticated masking arrangements may enable the optical shielding layer to provide additional functions. Please refer to FIG. 8, which shows an optical shielding layer that also serves as an anti-ESD (electrostatic discharge) device. Masking can be done along a corner of the substrate panel 10 prior to the electro-plating process for forming an extension leg A in connection with the optical shielding layer. Upon the completion of the electro-less plating process, the metal optical shielding layer may be connected to a ground pin of the sensor unit through the extension leg, thereby allowing the optical shielding layer to simultaneously act as an electrostatic shield for enhancing the anti-ESD performance of the sensor unit 1. Moreover, electrical contacts of the sensor unit 1 may be strategically created through the electro-less plating process by proper masking. As illustrated in FIG. 9, a plurality of electric contacts B may be created concurrently with the optical shielding layer by the electro-less plating process.

While the instant disclosure and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A proximity sensor comprising:
a substrate panel 10 having an emitter region and a receiver region;
an emitter unit 20 disposed on the emitter region of the substrate panel and configured to emit electromagnetic signals at a particular wavelength;
a receiver unit 30 disposed on the receiver region of the substrate panel and configured to respond to electromagnetic signals emitted by the emitter unit;
a transparent molding unit 40 disposed on the emitter region and the receiver region of the substrate panel 10 for covering the emitter unit 20 and the receiver unit 30, the transparent molding unit 40 being transparent to electromagnetic waves generated by the emitter unit; and
an optical shielding layer selectively disposed on the external surfaces of the substrate panel and the transparent molding unit, the shielding layer having an emitter window formed in correspondence to the emitter unit and a receiver window formed in correspondence to the receiver unit,
wherein the emitter window and the receiver window are correspondingly arranged toward a designated detection region.

2. The proximity sensor of claim 1, wherein the optical shielding layer is an electro-less plating layer.

3. The proximity sensor of claim 2, wherein the transparent molding unit comprises a separation structure correspondingly arranged between the emitter unit and the receiver unit.

4. The proximity sensor of claim 3, wherein the substrate panel comprises a partition groove between the emitter region and the receiver region thereof.

5. The proximity sensor of claim 4, wherein the optical shielding layer is disposed on surface of the partition groove of the substrate panel.

6. The proximity sensor of claim 4 wherein the partition groove of the substrate panel correspondingly aligns with the separation structure of the transparent molding unit.

7. The proximity sensor of claim 2, further comprising at least one electrical contact disposed by the electro-less plating process.

8. The proximity sensor of claim 2, wherein the optical shielding layer further comprises a groundling extension leg disposed by the electro-less plating process.

9. The proximity sensor of claim 1, wherein the emitter unit and the receiver unit operate in identical wavelength range, and wherein the wavelength range of the electromagnetic signal is in the infrared spectrum.

10. The proximity sensor of claim 9, wherein the transparent molding unit is transparent to electromagnetic signals in the infrared spectrum.

11. A proximity sensor comprising:
a substrate panel 10 having an emitter region and a receiver region;
an emitter unit 20 disposed on the emitter region of the substrate panel and configured to emit electromagnetic signals at a particular wavelength;
a receiver unit 30 disposed on the receiver region of the substrate panel and configured to be responsive to electromagnetic signals emitted by the emitter unit;
a transparent molding unit 40 transparent to electromagnetic waves generated by the emitter unit; and
an electro-less plating layer selectively disposed over the external surfaces of the substrate panel and the transparent molding unit, the shielding layer having an emitter window corresponding to the emitter unit and a receiver window corresponding to the receiver unit,

12. The proximity sensor of claim 11, wherein the transparent molding unit comprises a separation structure correspondingly disposed between the emitter unit and the receiver unit.

13. The proximity sensor of claim 12, wherein the substrate panel comprise a partition groove between the emitter region and the receiver region thereof.

14. The proximity sensor of claim 13, wherein the electro-less plating layer is disposed on surface of the partition groove.

15. The proximity sensor of claim 13 wherein the partition groove of the substrate panel correspondingly aligns with the separation structure of the transparent molding unit.

16. The proximity sensor of claim 11, wherein the electro-less plating layer further comprises a groundling extension leg.

17. The proximity sensor of claim 11, further comprising at least one electro-less plated electrical contact.

18. The proximity sensor of claim 11, wherein the emitter unit and the receiver unit operate in identical wavelength range, and wherein the wavelength range of the electromagnetic signal is in the infrared spectrum.

19. The proximity sensor of claim 18, wherein the transparent molding unit is transparent to electromagnetic signals in the infrared spectrum.
